(19) United States
(12) Patent Application Publication
(10) Pub. No.: US 2026/0332663 A1
(43) Pub. Date: Oct. 22, 2026

(54) TRANSMISSION OF DATA BLOCKS USING AN INTERMEDIATE STORAGE PROCESS

(71) Applicant: Siemens Mobility GmbH, München (DE)

(72) Inventor: Roland Porsch, Speichersdorf (DE)

(21) Appl. No.: 19/105,951

(22) PCT Filed: Aug. 16, 2023
(86) PCT No.: PCT/EP2023/072525

§ 371 Date: Feb. 24, 2025

(30) Foreign Application Priority Data
Aug. 24, 2022 (DE) 10 2022 208 768.2

(51) Int. Cl. H04L 67/06; H04L 67/1097; H04L 67/12; H04L 67/52

(52) U.S. Cl. CPC H04L 67/06; H04L 67/1097; H04L 67/12; H04L 67/52

(57) ABSTRACT

A method transmits files between a stationary communication participant and a mobile communication participant. In the process, a file is divided into multiple data blocks which are distributed to different storage devices arranged in a decentralized manner according to at least one parameter relating to the mobile communication participant. In order to transmit the file, the plurality of data blocks belonging to the file are transmitted between the mobile communication participant and specified storage devices. Alternatively or in addition thereto, the data blocks are transmitted between the stationary communication participant and specified storage devices.

The invention relates to a method for transferring a file between a mobile communication participant and a stationary communication participant and to a communication system for carrying out the method. The invention further relates to a computer program and a computer-readable medium.

When transferring data between a mobile communication participant and a stationary communication participant, the volume of data to be transferred is substantially limited from a technical standpoint by the available data transfer speed. In addition, a maximum possible data volume to be transferred is specified in order to avoid overloading a mobile radio network. If this volume of data is exceeded, large costs are usually incurred. The above-stated restrictions become particularly relevant in the case of communication between a land-side system and a vehicle fleet consisting of a plurality of vehicles. In such a case, the same file has often to be transferred from the land-side system to the individual vehicles. Furthermore, data of all kinds has to be continuously transferred from the individual vehicles to the land-side system. Data transfer speeds can, however, sometimes vary greatly depending on the location or route of the individual vehicles. This leads, on the one hand, to inefficient consumption of a maximum available volume of data. On the other hand, there is the problem that the number of vehicles and the volume of data to be transferred is constantly increasing. In order nevertheless to enable reliable data transfer, resources have hitherto been adapted to the prevailing requirements for the purpose of data transfer. However, the heavy load this approach places on mobile radio networks entails the risk of interruptions to the communication link or severe delays in file transfer.

The object of the invention is to enable improved file transfer between a mobile and a stationary communication participant.

This object is achieved by a method according to the features of independent claim 1. This object is additionally achieved by a communication system with the features of the independent system claim.

A further object of the invention is to provide a computer program and a computer-readable medium.

This object is achieved by a computer program according to the features of independent claim 14 and by a computer-readable medium according to the features of independent claim 15.

Further advantageous developments respectively constitute the subject matter of dependent claims.

The method according to the invention for transferring a file between a mobile communication participant and a stationary communication participant provides splitting the file to be transferred into a plurality of data blocks. These multiple data blocks are distributed to various storage devices arranged in a decentralized manner according to at least one parameter relating to the mobile communication participant. For the purpose of transferring the file, the plurality of data blocks belonging to this file are transferred between the mobile communication participant and predetermined storage devices. Alternatively or additionally for the purpose of transferring the file, the plurality of data blocks belonging to this file are transferred between the stationary communication participant and predetermined storage devices.

In the present context, the stated storage device is a data storage means as defined in information technology. In particular, the data storage means is set up to have digital data written to it or read from it. For example, the storage device may be a solid-state memory or a flash memory. In a preferred embodiment variant, the stated storage device is part of a data processing device. This data processing device is preferably set up to store, read, write, transfer, and/or manage data. The data processing device may, for example, be a computer, a microcontroller, or a comparable programmable hardware component including the stated storage device.

The stated parameter may be, for example, stopping places along a specified route, a property, such as membership of a vehicle fleet, or an operating state of the mobile communication participant.

This enables technical requirements on a communication network to be kept low. The data blocks can be transferred between the stationary communication participant and the storage devices using a low data transfer speed. In addition, transfers between the mobile communication participant and a storage device and between the storage device and the stationary communication participant can be temporally decoupled from one another. Appropriate selection of the parameter furthermore makes it possible to further improve file transfer efficiency. In addition, it is thus possible to provide an easily adaptable method.

An advantageous development provides that the plurality of data blocks of the file are distributed to predetermined ones of the stated storage devices according to an attribute of this file. The stated file attribute may be, for example, a type of content, a number of data records, a number of data records per data record type, a file creator, a file origin, a file size, a predetermined recipient group, a priority or a predetermined file type. The stated type of file content may be, for example, advertising data, media data, process data, service data, maintenance data, communication data, timetable data, vehicle data, or log data. In this way, it is possible to provide a file transfer method that is adaptable in a versatile and cost-effective manner. Available storage space can be put to efficient use by selectively distributing the files on the basis of their properties. In particular, it is possible to dispense with distributing all the files to be transferred to all the storage devices in a blanket manner.

An advantageous development furthermore provides that the plurality of data blocks are distributed to predetermined ones of the stated storage devices according to an item of location information relating to the mobile communication participant. The stated location information may be a GPS signal or information determined on the basis of sensors or IP addresses. Reliable and efficient data transfer can be achieved in this way. This makes it possible always to select the closest storage location and thus a high transfer quality for the purpose of file transfer. Furthermore, the file can accordingly be transferred from the stated storage devices to the mobile communication participant very largely independently of an external mobile radio network using local communication links. Local variation in the connection quality of the external mobile radio network is therefore of secondary importance. This furthermore makes it possible to transfer the data blocks at a very high data transfer speed. In addition, roaming charges arising from cross-border data transfer can additionally be avoided.

An advantageous development furthermore provides that the plurality of data blocks are distributed to predetermined ones of the stated storage devices according to an event plan relating to the mobile communication participant. In the present context, the stated event plan is understood to be a plan in which tasks, operating states, or other events concerning the mobile communication participant are described depending on a schedule. Such an event plan can be, for example, a timetable, a maintenance plan, or an inspection plan. With the assistance of the event plan, simple and reliable distribution of the data blocks can be planned cost-effectively. In particular, this makes it easily possible to utilize advantageous locations and longer idle times preferably for the purpose of transferring data blocks. The transfer of data blocks while the mobile communication participant is in motion can thus be advantageously avoided.

An advantageous development furthermore provides that, for the purpose of transferring the file from the stationary communication participant to the mobile communication participant, at least one data block of the plurality of data blocks is transferred to various ones of the stated storage devices. Elevated operational reliability can be provided in this way. If, for example, one storage device were to fail or not be reachable, the data block to be transferred can nevertheless be requested and downloaded from another storage device.

A further advantageous development provides that an item of assignment information relating to the storage locations of the data blocks is transferred for the purpose of transferring the file between the mobile communication participant and the stationary communication participant. The assignment information for example contains a list, by way of which a storage location is linked to a data block saved at this storage location. In this way an overview of the distributed data blocks can be provided cost-effectively.

An advantageous embodiment variant provides that the data blocks of the file to be transferred downloaded from the various storage devices by the mobile communication participant or the stationary communication participant are assembled on the basis of the assignment information. It is possible simply to dispense with time-consuming, usually error-prone searching for related data blocks of a file or compilation of data blocks with the assistance of tagging parameters.

A further advantageous embodiment variant provides that complete transfer of all the data blocks associated with a file is verified on the basis of the assignment information. Operational reliability can accordingly be further enhanced. In particular, very largely error-free file transfer can be provided in this way. The assignment information can furthermore be used to easily determine a checksum or such a checksum may already have been transferred therewith. Completeness can be checked cost-effectively in this way.

A further advantageous development provides that receipt of all the data blocks belonging to a file is confirmed by transferring a confirmation of receipt. This makes it possible to make efficient use of limited storage space. For example, temporarily stored data blocks can be deleted in response to the confirmation of receipt, while also taking account of further specifications, so freeing up occupied storage space.

The method according to the invention can be carried out by way of the communication system according to the invention.

The communication system according to the invention has a mobile communication participant and a stationary communication participant. Furthermore, the communication system according to the invention has a data processing system with a plurality of storage devices arranged in a decentralized manner. The stated storage devices are in particular storage devices of the type already previously described in the context of the method according to the invention. The stated storage devices are furthermore connected to the stationary communication participant by way of a network connection. Data blocks of a file are furthermore in each case transferable from the stationary communication participant to the mobile communication participant by way of the various storage devices.

This communication system makes it possible to achieve reliable and rapid file transfer. Temporarily storing the data blocks on various storage devices makes it possible to relieve the load on the stated network connection. An arising load of data volumes to be transferred can be uniformly distributed over a specified period of time. In addition, data transfer by way of the stated network connection can be effected using a low data transfer speed.

An advantageous development of the communication system provides that the mobile communication participant takes the form of a vehicle. In particular, the vehicle takes the form of a rail-borne vehicle. In this way, common problems in mobile data transfer, such as for example dropped connections or low data transfer rates in mobile radio networks, can be overcome in a straightforward and cost-effective manner. Reliable and cost-effective file transfer can furthermore be enabled in this way.

One advantageous development of the communication system furthermore provides that the storage devices are arranged along a specified route of the mobile communication participant. Storage devices are, for example, arranged at stopping points, maintenance depots and/or a switchyard. This makes it possible to provide and utilize a high transmission quality at the intended locations of the mobile communication participant. In particular, data loss or inefficient use of an available data volume, for example due to dropped connections, can be avoided in this way. It is furthermore conceivable for storage devices to be arranged at predetermined distances along the stated route.

A further advantageous development of the communication system provides that the storage devices are in each case part of a data processing device arranged at the location of the respective storage device. A dedicated local communication network can be provided by way of the data processing device. A direct connection between the storage device and a data processing device furthermore enables rapid transfer of data blocks. This furthermore makes it possible to provide a high level of reliability and elevated operational security in the transfer of data blocks.

The invention furthermore provides a computer program which comprises commands which, on execution of the computer program by a data processing device, cause the communication system according to the invention to carry out the method according to the invention. The stated data processing device in particular comprises the previously described data processing device.

The invention furthermore provides a computer-readable medium including instructions which, on execution thereof by a data processing device, cause the communication system according to the invention to carry out the method according to the invention. The stated data processing device in particular comprises the previously described data processing device. The computer-readable medium may be, for example, a CD-ROM, a DVD, a USB or flash memory or a non-physical medium, such as a data stream and/or a data carrier signal.

The above-described characteristics, features and advantages of the invention and the manner in which they are achieved are described in conjunction with the figures in the following description of the embodiments of the invention. Where appropriate, the same reference signs are used in the figures for the same or corresponding elements of the invention. The exemplary embodiment and described variants thereof serve to explain the invention and do not limit the invention to the combinations of features stated therein, not even in respect of functional features. In addition, all the features stated in the exemplary embodiment can be considered in isolation and suitably combined with the features of any desired claim.

In the Figures:

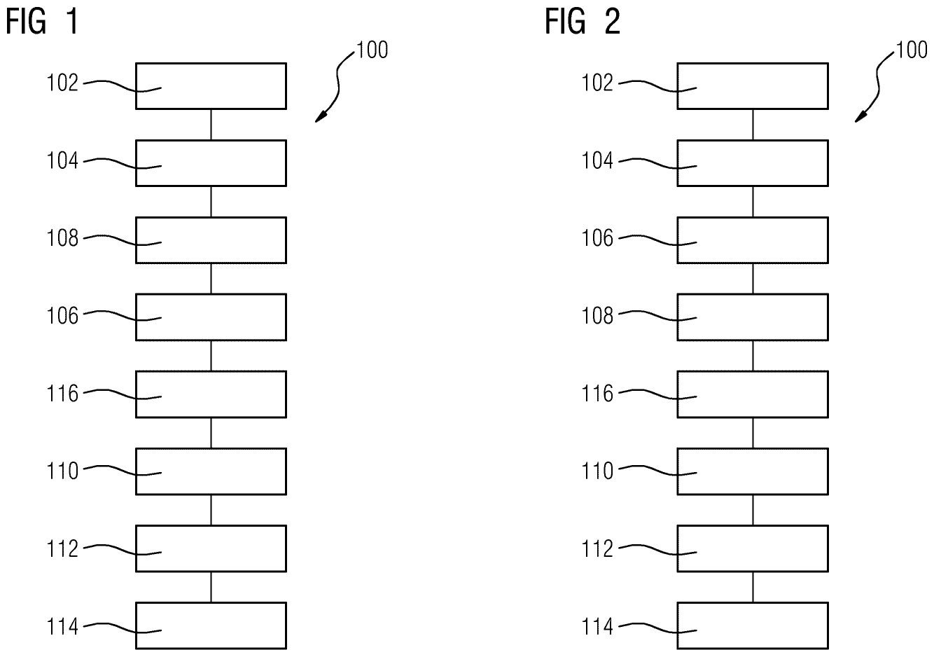

FIG. 1 shows a schematic illustration of a first variant of an exemplary method for transferring data blocks of a file from a land-side participant to a vehicle;

FIG. 2 shows a schematic illustration of a second variant of the exemplary method for transferring data blocks of a file from the vehicle to the landside participant;

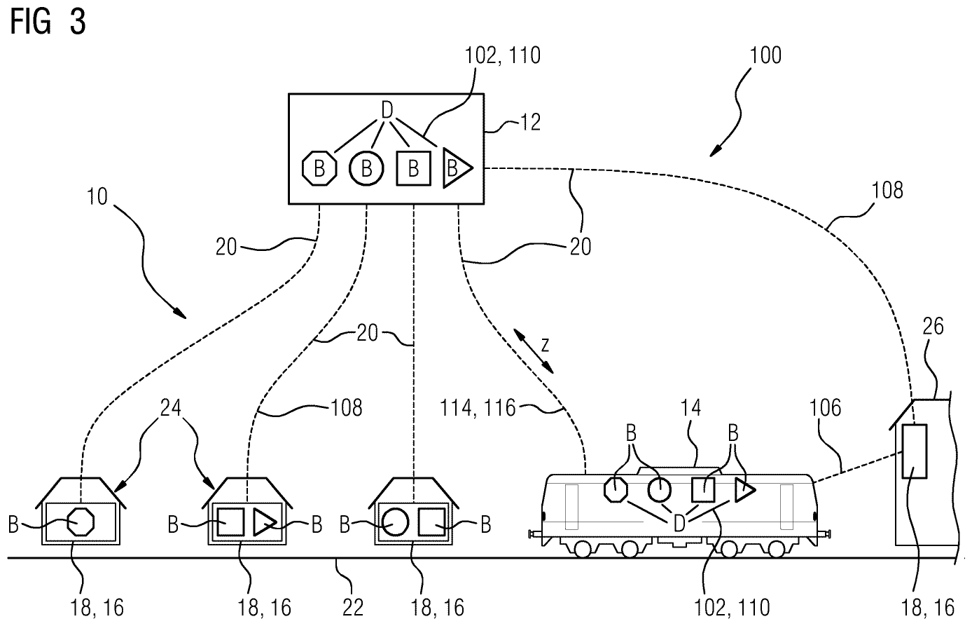

FIG. 3 shows an exemplary embodiment of a communication system by way of which the variants of the exemplary method illustrated in FIG. 1 and FIG. 2 can be carried out.

FIG. 1 shows a first variant of an exemplary method 100 for transferring a file D between a land-side participant 12 and a vehicle 14 in the form of a schematic flowchart. The exemplary method 100 can be carried out by way of the communication system 10 shown in FIG. 3. The variant of the exemplary method 100 described in connection with FIG. 1 relates to the transfer of a file D starting from the landside participant 12 to the vehicle 14.

The file D to be transferred is split 102 into a plurality of data blocks B. It is conceivable for account to be taken of an event plan of the vehicle 14 when splitting 102 the file. For example, the size of a data block B can be adapted on the basis of a predicted layover time at a predetermined location. The stated data blocks B are then distributed 104 to various storage devices 18 arranged in a decentralized manner according to a parameter relating to the vehicle 14.

For the stated distribution 104 of the data blocks B, intended stopping places of the vehicle 14 along a route 22 intended for this vehicle 14 are, for example, initially used as parameters in the present case. In this way, the data blocks B to be transferred are distributed 104 to those storage devices 18 which coincide spatially with stopping places of the vehicle 14. Alternatively or additionally, characteristics of the vehicle 14, such as for example membership of a vehicle fleet or a customer group, or an operating state, for example relating to a break, driving mode or servicing, can be used as parameters for the stated distribution 104. If data blocks B of a plurality of files D to be transferred are furthermore to be distributed 104, the data blocks B are distributed 104 according to an attribute of a respectively associated file D to the storage devices 18 selected according to the above-stated parameter. In the example described here, the relevance of the file D to be transferred is used as the attribute. In this way, data blocks B of a file D to which a high level of relevance is assigned are distributed to those storage devices 18 along the route 22 which are arranged at the beginning of this intended route 22. On the other hand, data blocks B of a file D to which a low level of relevance is assigned are distributed 104 to storage devices 18 which are arranged in the middle or late part of the route 22. In addition, in the exemplary method 100 currently being described, the data blocks B to be transferred are distributed 104 to the stated storage devices 18 on the basis of a timetable relating to the vehicle 14. In this way, it is possible to take account of a stopping time and thus a possible transfer time between a storage device 18 and the vehicle 14. If, for example, an extended layover time of the vehicle 14 is scheduled at a predetermined stopping point 24, a relatively large number of data blocks B or a relatively large volume of data intended for the vehicle 14 can be saved on this storage device 18. If, on the other hand, just a short layover time is scheduled at a predetermined stopping point 24, a number of saved data blocks B or a volume of data intended for this vehicle 14 can be kept low. Alternatively or additionally, a maintenance plan can be used for the purpose of distributing 104 the data blocks B to the stated storage devices 18. A layover of the vehicle 14 in a maintenance depot 26 is conventionally of extended duration, whereby a plurality of data blocks B and/or a large volume of data is transferable 106 from a storage device 18 arranged in the maintenance depot 26 to the vehicle 14.

For the purpose of reliable transfer of the file D, the present exemplary method 100 furthermore provides that individual data blocks B are transferred 108 from the landside participant 12 to a plurality of the various storage devices 18. In this way, it is possible to prevent an opportunity for transferring 106 a data block B from a storage device 18 to the vehicle 14 from being missed. If, for example, a communication link between a storage device 18 and the vehicle 14 is terminated or cut off before the data block B has been successfully transferred 106, the vehicle 14 still has an opportunity to download 106 this data block B from another storage device 18.

Furthermore, the land-side participant 12 creates an item of assignment information Z, by way of which the distribution 104 of the data blocks B to the various storage devices 18 is documented and which is transferred 116 to the vehicle 14. This assignment information Z includes information relating to the storage locations of the data blocks B. In this way, the vehicle 14 is cost-effectively enabled to assign the data blocks B initially read 106 at random from various storage devices 18 by the vehicle 14 to a file D to be transferred. Using the assignment information Z, the file D to be transferred is assembled 110 in the vehicle 14. Furthermore, a checksum is transferred 116 with the assignment information Z in the course of the exemplary method 100 currently being described. This enables the vehicle 14 to verify 112 whether all of the data blocks B associated with a file D have been completely transferred 106 from the storage devices 18 to the vehicle 14. As soon as completeness has been verified 112, the vehicle 14 in the present case transfers a confirmation of receipt to the land-side participant 12 in order to confirm 114 complete receipt of the file D. Such a confirmation of receipt 114 enables the land-side participant 12 to remove data blocks B from the storage devices 18, so freeing up storage space for further data blocks B of other files D to be transferred.

FIG. 2 shows a second variant of the exemplary method 100, wherein a file D is transferred from the vehicle 14 to the land-side participant 12. In contrast with the first variant of the exemplary method 100 described in connection with FIG. 1, a file D is transferred in the opposite direction.

As previously described, the file D to be transferred is firstly split 102 into a plurality of data blocks B. In contrast with the previously described variant of the method 100, the plurality of data blocks B of the file D to be transferred are distributed 104 to the storage devices 18 according to a location of the vehicle 14. The stated distribution 104 is effected by a change in location of the vehicle 14. As soon as the vehicle 14 approaches a storage device 18, the latter is used for the purpose of transferring 106 at least one data block B from the vehicle 14 to the storage device 18. It is additionally conceivable for an event plan of the vehicle 14 to be taken into account during distribution 104 such that, in addition to the spatial vicinity between the vehicle 14 and the storage device 18, a scheduled layover time can also be taken into account during distribution 104.

As already described in connection with FIG. 1, in the case of a plurality of files D to be transferred from the vehicle 14 to the land-side participant 12, distribution 104 takes place according to the relevance of the respective file D. Alternatively or additionally, further file attributes, such as for example a file type or type of file content, can be taken into account during distribution 104. Furthermore, as already described in connection with FIG. 1, an event plan of the vehicle 14 can also be taken into account when splitting 102 the data blocks B. For example, a timetable and a maintenance schedule for the vehicle 14 can be used for the purpose of splitting 102 the file D into data blocks B as required. Accordingly, data blocks B can in each case be transferred 106 to this storage device 18 as a function of a scheduled layover time of the vehicle 14 close to this storage device 18.

Once a data block B has been successfully transferred 106 from the vehicle 14 to a storage device 18, the vehicle 14 documents a storage location of the data block B and links it to the storage device 18. In this way, the vehicle 14 creates an item of assignment information Z. As soon as all the data blocks B of a file D to be transferred have been transferred 106 to storage devices 18, the vehicle 14 transfers this assignment information Z to the land-side participant 12. With the assistance of the assignment information Z, the necessary data blocks B are then transferred 108 between the corresponding storage devices 18 and the land-side participant 12. As already described in connection with FIG. 1, a checksum is transferred 116 together with the assignment information Z for the purpose of verifying 112 complete transfer of the file D to be transferred. Once all the data blocks B belonging to a file D are available, they are assembled 110 on the basis of the assignment information Z. In the present example, the transferred checksum is used to verify 112 whether all the data blocks B are available. Once verification 112 is successful, the land-side participant 12 transfers a confirmation of receipt 114 to the vehicle 14. Once this confirmation of receipt 114 has been received, the vehicle 14 can delete the file D to be transferred. This makes it possible to make efficient use of limited available storage space.

FIG. 3 shows a schematic representation of an exemplary embodiment of a communication system 10. This communication system 10 includes by way of example the above-stated vehicle 14, which takes the form, by way of example, of a rail-borne passenger transport vehicle. FIG. 3 furthermore shows the above-stated land-side participant 12, which has a stationary server. The communication system 10 furthermore has a data processing system 16. This data processing system 16 includes the likewise previously stated storage devices 18 arranged in a decentralized manner. Each storage device 18 is, by way of example, part of a data processing device, not shown in greater detail, arranged at the same location. Each of the stated storage devices 18 arranged in a decentralized manner is furthermore connected by way of a network connection 20 to the land-side participant 12 for the purpose of transferring data blocks B of a file D. In addition, the plurality of storage devices 18 arranged in a decentralized manner are set up to transfer 106, 108 the file D to be transferred between the land-side participant 12 and the vehicle 14 in the form of data blocks B.

FIG. 3 furthermore shows by way of example that the stated storage devices 18 are arranged along an intended route 22 of the vehicle 14. The storage devices 18 are, by way of example, located at stopping points 24 and in a maintenance depot 26. It is furthermore conceivable for further storage devices 18 to be arranged in a distributed manner not shown in greater detail at predetermined distances along the route 22.

The variants of the exemplary method 100 described in connection with FIG. 1 and FIG. 2 can in particular be carried out by way of the communication system 10 described by way of example in connection with FIG. 3.

Although the invention has been illustrated and described in greater detail with reference to the preferred embodiments, the invention is not limited by the disclosed examples and other variations may be derived therefrom by a person skilled in the art without going beyond the scope of protection of the invention.

1-15. (canceled)

16. A method for transferring a file between a stationary communication participant and a mobile communication participant, which comprises the steps of:
splitting the file to be transferred into a plurality of data blocks;
distributing the plurality of data blocks to various storage devices disposed in a decentralized manner according to at least one parameter relating to the mobile communication participant; and
transferring the plurality of data blocks belonging to the file between the mobile communication participant and the various storage devices being predetermined storage devices and/or transferring the plurality of data blocks between the stationary communication participant and the predetermined storage devices for a purpose of transferring the file.

17. The method according to claim 16, which further comprises distributing the plurality of data blocks of the file to predetermined ones of the various storage devices according to an attribute of the file.

18. The method according to claim 16, which further comprises distributing the plurality of data blocks to predetermined ones of the various storage devices according to an item of location information relating to the mobile communication participant.

19. The method according to claim 16, which further comprises distributing the plurality of data blocks to predetermined ones of the various storage devices according to an event plan relating to the mobile communication participant.

20. The method according to claim 16, wherein, for a purpose of transferring the file from the stationary communication participant to the mobile communication participant, at least one data block of the plurality of data blocks is transferred to various ones of the various storage devices.

21. The method according to claim 16, which further comprises transferring an item of assignment information relating to storage locations of the data blocks for a purpose of transferring the file between the mobile communication participant and the stationary communication participant.

22. The method according to claim 21, wherein the data blocks of the file to be transferred which are downloaded from the various storage devices by the mobile communication participant or the stationary communication participant are assembled on a basis of the assignment information.

23. The method according to claim 21, which further comprises verifying a complete transfer of all the data blocks associated with the file on a basis of the assignment information.

24. The method according to claim 16, which further comprises confirming a receipt of all the data blocks belonging to the file by transferring a confirmation of receipt.

25. A communication system, comprising:
a stationary communication participant;
a mobile communication participant;
a data processing system having a plurality of storage devices disposed in a decentralized manner and are connected in each case by way of a network connection to said stationary communication participant and by way of which a file is in each case transferable between said stationary communication participant and said mobile communication participant;
the communication system configured to:
split the file to be transferred into a plurality of data blocks;
distribute the plurality of data blocks to said storage devices disposed in the decentralized manner according to at least one parameter relating to said mobile communication participant; and
transfer the plurality of data blocks belonging to the file between said mobile communication participant and said storage devices being predetermined storage devices and/or transferring the plurality of data blocks between said stationary communication participant and said predetermined storage devices for a purpose of transferring the file.

26. The communication system according to claim 25, wherein said mobile communication participant is a vehicle.

27. The communication system according to claim 25, wherein said storage devices are disposed along a specified route of said mobile communication participant.

28. The communication system according to claim 25, wherein said storage devices are in each case part of a data processing device disposed at a location of said storage devices.

29. The communication system according to claim 26, wherein said vehicle is a rail-borne vehicle.

30. A non-transitory computer program which, on execution thereof, causes the communication system according to claim 25 to perform a method for transferring a file between the stationary communication participant and the mobile communication participant, the method comprises the steps of:
splitting the file to be transferred into a plurality of data blocks;
allocating the plurality of data blocks to the storage devices disposed in the decentralized manner according to at least one parameter relating to the mobile communication participant;
transferring the plurality of data blocks belonging to the file between the mobile communication participant and the storage devices being predetermined storage devices and/or transferring the plurality of data blocks between the stationary communication participant and the predetermined storage devices for a purpose of transferring the file.

31. A non-transitory computer-readable medium having computer executable instructions which cause a communication system to perform a method for transferring a file between a stationary communication participant and a mobile communication participant of the communication system, the method comprises the steps of:
splitting the file to be transferred into a plurality of data blocks;
allocating the plurality of data blocks to various storage devices of the communication system disposed in a decentralized manner according to at least one parameter relating to the mobile communication participant; and
transferring the plurality of data blocks belonging to the file between the mobile communication participant and the various storage devices being predetermined storage devices and/or transferring the plurality of data blocks between the stationary communication participant and the predetermined storage devices for a purpose of transferring the file.
